(19) United States
(12) Patent Application Publication
(10) Pub. No.: US 2003/0195129 A1
(43) Pub. Date: Oct. 16, 2003

(54) Laundering pretreatment composition for clothing

(76) Inventors: Akira Ishikawa, Wakayama (JP); Masatsugu Ito, Wakayama (JP); Kazutoshi Ide, Wakayama (JP); Hiroshi Nishimura, Wakayama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/380,767

(22) PCT Filed: Jul. 23, 2002
(86) PCT No.: PCT/JP02/07441

(30) Foreign Application Priority Data
Jul. 24, 2001 (JP) 2001-222880

(51) Int. Cl. C11D 1/00

(52) U.S. Cl. 510/276

(57) ABSTRACT

The present invention provides a prewashing treatment composition for clothes ensuring that superb washing ability is obtained by washing after it is applied to materials to be washed. The prewashing treatment composition comprises (a) a surfactant, (b) a chelating agent having a specified calcium-chelating capacity and a specified stability constant of calcium complex and a molecular weight of 1000 or less, (c) water and (d) an alkali agent in each specified ratio, and has a pH of 7.5 to 12 at 20° C.

### FIELD OF THE INVENTION

The present invention relates to a prewashing treatment composition for clothes which is used by applying it to materials to be washed.

### PRIOR ART

When a partial stain such as dirt on the collar and sleeves and a stain of spilled foods is heavy, the stain is removed only insufficiently and remains as a spot only by usual washing. Generally, the concentration of a detergent is raised by applying the detergent directly to a soiled part to deal with the dirt on the collar and sleeves and spot stains. For example, a pre-spotting detergent used by applying it to laundry items and washing is disclosed in JP-A Nos. 60-101199, 10-298599, 2001-181692 and 11-61196. Each of these detergents a large amount of contains many surfactants and therefore can be used as a detergent as it is. These detergents, however, lack in applicability and penetration into clothes and are therefore inferior in the ability of washing out sebaceous stains. Therefore, these detergents have detergency insufficient to wash out, particularly, dirt, such as dirt on the collar and sleeves, originated from humankind.

### DISCLOSURE OF THE INVENTION

It is an object of the present invention to provide a prewashing treatment composition for clothes which ensures high detergency by washing after it is applied to materials to be washed.

The present invention relates to a prewashing treatment composition for clothes comprising (a) 0.05 to 10 mass % of a surfactant (hereinafter referred to as “component (a)”), (b) 1 to 30 mass % of a chelating agent (hereinafter referred to as “component (b)”) having a calcium-chleating capacity of 200 to 600 CaCO₃ mg/g, a stability constant of calcium complex of 4 to 10 and a molecular weight of 1000 or less, (c) 50 to 95 mass % of water (hereinafter referred to as “component (c)”) and (d) 1 to 30 mass % of an alkali agent (hereinafter referred to as “component (d)”), and having a pH of 7.5 to 12 measured at 20° C.

Also, the present invention relates to a method of washing clothes, the method comprising applying the aforementioned prewashing treatment composition for clothes to clothes prior to washing in an atomized or foamed state and then washing the clothes by using a detergent. Namely, the present invention provides a method of washing clothes, the method comprising applying the aforementioned prewashing treatment composition for clothes to clothes and then washing the clothes by using a detergent. The present invention ensures that particularly sebaceous stains can be thoroughly washed out. The composition of the present invention well penetrates into sebaceous stains, swells these stains and makes calcium in these stains to be freed and to be solubilized. The composition of the present invention contains surfactants in a smaller amount and a chelating agent in a larger amount. The composition of the present invention can be easily applied to clothes.

### DETAILED DESCRIPTIONS OF THE INVENTION

<Prewashing Treatment Composition for Clothes>

The prewashing treatment composition for clothes according to the present invention has a pH of 7.5 to 12 at 20° C. when measured according to the method described in JIS K 3362: 1998. The pH is preferably 8 to 11, more preferably 8.5 to 11, still more preferably 9 to 11 and particularly preferably 10 to 11 in view of detergency and safety.

The viscosity of the prewashing treatment composition for clothes according to the present invention is preferably 1 to 50 mPa.s (B-type viscometer, 60 r/min) at 20° C. from the viewpoint of discharging easiness from a container when it is applied. The viscosity is more preferably 1 to 30 mPa.s, still more preferably 1 to 20 mPa.s and particularly preferably 2 to 15 mPa.s when the composition is discharged, particularly, in an atomized or foamed state.

The prewashing treatment composition for clothes according to the present invention may be discharged from the opening of a discharge portion of a container and applied directly to clothes to be washed prior to washing, applied through a sponge, brush or roll or applied after it is weighed using a measuring container. It is more preferable to apply the composition in an atomized or foamed state from the viewpoint of convenience. The composition is applied still more preferably in a foamed state to avoid such a case where users aspirate fine mists. The clothes treated prior to washing in this manner is preferably washed (by a washing machine or the like) next using a detergent (a usual washing detergent or the like).

<Component (a)>

The prewashing treatment composition for clothes according to the present invention contains 0.05 to 10 mass % of the component (a). The content of the component (a) is preferably 0.1 to 9 mass %, more preferably 0.5 to 8 mass % and still more preferably 1 to 7 mass % in view of detergency and applicability.

Examples of the surfactant include nonionic surfactants, anionic surfactants, cationic surfactants and amphoteric surfactants and the like. Among these surfactants, amphoteric surfactants are preferably contained in view of detergency. The amphoteric surfactant is contained in an amount of preferably 50 mass % or more, more preferably 60 mass % or more and particularly preferably 70 mass % or more of the surfactants.

Examples of the amphoteric surfactant include alkylbetaine, imidazoliniumbetaine, amine oxide and alkylalanine and the like. Compounds represented by the following formulae (II) or (III) are preferably contained in an amount of 50 mass % or more, more preferably 60 mass % or more and particularly preferably 70 mass % or more. Among these compounds, compounds represented by the formula (II) are preferably contained in an amount of 50 mass % or more, more preferably 60 mass % or more and particularly preferably 70 mass % or more of the surfactants. Amidopropylamine oxide is particularly preferable.

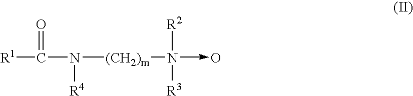

wherein R¹ represents an alkyl group or an alkenyl group having 7 to 20 carbon atoms and preferably 9 to 15 carbon atoms, R² and R³ respectively represent an alkyl group or an alkenyl group having 1 to 3 carbon atoms and preferably an alkyl group having one carbon atom or a hydrogen atom, R⁴ represents a hydrogen atom or an alkyl group or an alkenyl group having 1 to 5 carbon atoms and preferably a hydrogen atom or a methyl group, m denotes a number of 1 to 5 and preferably 3.

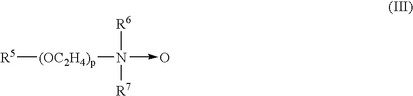

wherein R⁵ represents an alkyl group or an alkenyl group having 8 to 20 carbon atoms and preferably 12 to 14 carbon atoms, R⁶ and R⁷ respectively represent an alkyl group or an alkenyl group having 1 to 3 carbon atoms and preferably an alkyl group having one carbon atom or a hydrogen atom, p denotes a number of 0 to 10 and preferably 2 to 4.

Examples of the anionic surfactant include sulfates of alcohols, sulfates of ethoxylates of alcohols, alkylbenzene sulfonates, paraffin sulfonates, α-olefin sulfonates, α-sulfo-fatty acid salts, α-sulfo-fatty acid alkyl ester salts or fatty acid salts. Particularly, linear alkylbenzene sulfonates in which the number of carbons of the alkyl chain is 12 to 14 and alkyl sulfates having 12 to 18 carbon atoms are preferable. As the counter ion, alkali metals and alkanolamine salts are preferable.

As the nonionic surfactant, polyoxyalkylene alkyl ether, polyoxyalkylene alkylphenyl ether, polyoxyalkylenesorbitan fatty acid ester, polyoxyalkylene glycol fatty acid ester, polyoxyethylene-polyoxypropylene block polymers, fatty acid alkanol amide, alkyl polyglycoside and the like are preferable. Particularly, alkyl-polyglycoside is preferable.

Examples of the cationic surfactant include quaternary type mono-long-chain alkyl or di-long-chain alkyl ammonium salts and the like.

<Component (b)>

The prewashing treatment composition for clothes according to the present invention contains 1 to 30 mass % of the component (b). The content of the composition is preferably 2 to 25 mass %, more preferably 3 to 20 mass %, still more preferably 3.5 to 15 mass % and most preferably 4 to 12 mass % in view of detergency and applicability. The molecular weight is preferably 800 or less and more preferably 600 or less in view of detergency.

The calcium-chelating capacity of the component (b) is 200 to 600 CaCO₃ mg/g. The capacity is preferably 250 to 550 CaCO₃ mg/g and more preferably 300 to 500 CaCO₃ mg/g in view of detergency and adaptability to the environment. The stability constant of calcium complex is 4 to 10, and preferably 5 to 9 and more preferably 6 to 8, still more preferably 6.5 to 8 in view of detergency and adaptability to the environment.

In the invention, the stability constant of calcium complex and the calcium-chelating capacity mean those found by the following method.

(Method of Measuring the Stability Constant of Calcium Complex)

A 0.1 mol/l NH₄Cl—NH₄OH (pH 10) solution is prepared as a buffer solution. All sample solutions are prepared using this buffer solution. An ion meter 920A manufactured by Orion and a Ca²⁺ ion electrode are used to measure the concentration of Ca²⁺. First, the relationship between the concentration of calcium chloride and the potential of the electrode is found to make a calibration curve. A solution containing 5.36×10⁻² mol/l of calcium chloride and a solution containing 5.36×10⁻⁴ mol/l of a chelating agent sample are prepared. 1 ml of the calcium chloride solution is added to 100 ml of the chelating agent sample solution and the mixture is stirred for 5 minutes. The concentration of remaining Ca²⁺ is measured using the Ca²⁺ ion electrode. Supposing that the chelating agent forms a chelating complex in combination with Ca²⁺ in a ratio of 1:1, the stability constant of calcium complex (Ca stability constant) is found from the following equation.

Ca Stability Constant=

log₁₀([M]_{Total}−[M])/[M]{[L]_{Total}−([M]_{Total}−[M])}

where:

[M]ₜₒₜₐₗ: initial Ca²⁺ concentration

[L]ₜₒₜₐₗ: initial chelating agent concentration

[M]: remaining Ca²⁺ concentration

(Method of Measuring the Calcium-Chelating Capacity)

The calcium-chelating ability (Ca-capture amount) is found using the method described in the publication of JP-A No. 3-277696, page 3, right lower column, line 6 to page 4, left upper column, line 6 (provided that the anionic surfactant is converted into a chelating agent in reading)

Examples of the component (b) include compounds having 2 to 5 and preferably 3 to 5 COOM groups (M: H, Na, K or NH₄) in the molecule. Among these compounds, compounds represented by the following formula (I) are preferable from the viewpoint of detergency and adaptability to the environment.

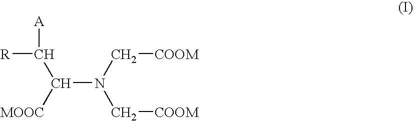

wherein R represents —(CH₂)ₙ-A, A represents H, OH or COOM, M represents H, Na, K or NH₄ and preferably Na and n denotes a number from 0 to 5.

Particularly, amino acid chelating agents such as methylglycinediacetic acid are preferable.

In the present invention, the ratio (a)/(b) by mass of the component (b) and preferably the compound represented by the formula (I) to the component (a) and preferably an amphoteric surfactant is preferably 3/1 to 1/5, more preferably 2/1 to 1/3, still more preferably 1/1 to 1/3 and particularly preferably 1/1 to 1/2.

<Component (c)>

The prewashing treatment composition for clothes of the present invention contains 50 to 95 mass % of the component (c) The content of the component (c) is preferably 55 to 90 mass %, more preferably 60 to 85 mass % and still more preferably 65 to 80 mass % in view of detergency and applicability.

<Component (d)>

The prewashing treatment composition for clothes of the present invention contains 1 to 30 mass % of the component (d). The content of the component (d) is preferably 3 to 25 mass %, more preferably 5 to 20 mass % and still more preferably 5 to 15 mass % in view of detergency and applicability.

Examples of the component (d) include alkali metal carbonates such as sodium carbonate, sodium bicarbonate, potassium carbonate and potassium bicarbonate, alkali metal silicates such as sodium silicate and potassium silicate, polyphosphates such as orthophosphates, methaphosphates, pyrophosphates and hexamethaphosphates, alkanolamines such as monoethanolamine, diethanolamine and triethanolamine, disodium hydrogen-phosphate, trisodium phosphate and borates.

The component (d) is preferably a compound having the characteristics that the maximum pH of an aqueous solution or a dispersion containing the component (d) at a concentration of 0.025 mass % is 10 or more (20° C.) and 10 ml or more of an aqueous 0.1N hydrochloric acid solution is required to adjust 1 l of the aqueous solution or dispersion to pH 9 (20° C.). Examples of such a compound include sodium carbonate, potassium carbonate, sodium silicate, trisodium phosphate and monoethanolamine and the like. Among these compounds, sodium carbonate, potassium carbonate and sodium silicate are more preferable and sodium carbonate is particularly preferable.

<Component (e)>

The prewashing treatment composition for clothes of the present invention contains a hydrotropic agent (component (e)) in an amount of preferably 1 to 30 mass %, more preferably 2 to 15 mass % and still more preferably 3 to 10 mass % in view of low temperature stability and applicability.

Examples of the component (e) include lower alcohols having 1 to 4 carbon atoms such as methanol, ethanol, propanol, glycerol, ethylene glycol and propylene glycol, toluenesulfonic acid or its salts, xylenesulfonic acid or its salts and compounds represented by the following formula (IV).

X—(Ph)—O(CH₂CH₂O)ₚ(CH₂CHRO)_{q}Y (IV)

wherein X represents a hydrogen atom, an alkyl group or an alkenyl group having 1 to 4 carbon atoms, a hydroxyl group or a halogen, Y represents a hydrogen atom, a methyl group or an ethyl group, Ph represents a phenylene group, R represents a hydrogen atom, a methyl group or an ethyl group, p denotes a number from 1 to 6 and preferably 1 to 3 and q denotes a number from 0 to 4 and preferably 0 to 2, provided that p+q is 1 to 10 and preferably 1 to 6.

Among these compounds, lower alcohols having 2 or 3 carbon atoms and p-toluenesulfonic acid or its salts are more preferable.

The prewashing treatment composition for clothes according to the present invention preferably contains (f) a chelating agent (hereinafter referred to as “component (f)”) having a calcium-chelating capacity of 20 to 500 CaCO₃ mg/g, a stability constant of calcium complex of 1 to 8 and a molecular weight of 2000 or more in an amount of 0.05 to 15 mass %. The amount of the component (f) is preferably 0.1 to 12 mass %, more preferably 0.2 to 10 mass %, still more preferably 0.3 to 5 mass % and most preferably 0.5 to 3 mass % in view of detergency and applicability.

In the present invention, the ratio by mass of the component (f) to the component (b), namely (f)/(b) is preferably 1/50 to 1/1, more preferably 1/30 to 1/1 and particularly preferably 1/10 to 1/2 in view of detergency.

Also, the molecular weight of the component (f) is 2000 or more, preferably 2000 to 20000 and more preferably 2000 to 15000 in view of stability and detergency. When the component (f) is a polymer, its molecular weight is a weight average molecular weight which is to be measured by gel permeation chromatography (standard material: polystyrene).

Also, the calcium-chelating capacity of the component (f) is 20 to 500 CaCO₃ mg/g. The calcium-chelating capacity is preferably 40 to 400 CaCO₃ mg/g and more preferably 100 to 350 CaCO₃ mg/g in view of detergency. In the present invention, it is preferable that the calcium-chelating capacity of the component (b) be greater than that of the component (f). More concretely, it is preferable that (the calcium-chelating capacity (CaCO₃ mg/g) of the component (b)×the concentration (mass %) of the component (b) in the composition) be greater than (the calcium-chelating capacity (CaCO₃ mg/g) of the component (f)×the concentration (mass %) of the component (f) in the composition). Further, (the calcium-chelating capacity (CaCO₃ mg/g) of the component (b)×the concentration (mass %) of the component (b) in the composition)−(the calcium-chelating capacity (CaCO₃ mg/g) of the component (f)×the concentration (mass %) of the component (f) in the composition) is preferably 200 to 4000 (CaCO₃ mg/g−mass %) and more preferably 500 to 3000 (CaCO₃ mg/g mass %) Also, the stability constant of calcium complex of the component (f) is 1 to 8. The stability constant of calcium complex is preferably 1 to 6, more preferably 2 to 6 and still more preferably 2 to 4 in view of detergency. In the present invention, the stability constant of calcium complex of the component (b) is preferably greater than that of the component (f). Specifically, (the stability constant of calcium complex of the component (b))−(the stability constant of calcium complex of the component (f)) is preferably 2 to 6 and more preferably 2 to 4.

Examples of the component (f) include compounds having a COOM group (M represents H, Na, K or NH₄) in the molecule. Among these compounds, polyacrylic acids or their salts, polymaleic acids or their salts, carboxymethyl cellulose, acrylic acid/maleic acid copolymers or their salts, maleic acid anhydride/diisobutylene copolymers or their salts, maleic acid anhydride-methyl vinyl ether copolymers or their salts, maleic acid anhydride/isobutylene copolymers or their salts, maleic acid anhydride/vinyl acetate copolymers or their salts and organic polyvalent carboxylic acids and/or their salts such as polymers described in the publication of JP-A No. 59-62614, claims 1 to 21 (page 1, 3rd column, line 5 to page 3, 4th column, line 14) and/or their salts. Particularly, polyacrylic acids or their salts are preferable.

<Other Components>

The prewashing treatment composition for clothes according to the present invention may be compounded of (1) 0.01 to 10 mass % of an antiredepositioning agent such as polyethylene glycol having an average molecular weight of 5000 or more and a naphthalene sulfonate formalin condensate, (2) 0.01 to 10 mass % of a dye-transfer preventive agent such as polyvinylpyrrolidone, (3) 0.01 to 2 mass % of a foaming regulator such as silicone and silica, (4) 0.01 to 2 mass % of an antioxidant such as butylhydroxytoluene, distyrenated cresol, sodium sulfite and sodium hydrogen sulfite, (5) colorants, (6) enzymes such as amylase, protease, lipase and cellulase, (7) enzyme stabilizers such as calcium chloride, calcium sulfate, formic acid and boric acid (boron compounds), (8) perfumes and (9) antibacterial and antiseptic agents and the like.

### EXAMPLES

Examples 1 to 14 and Comparative Examples 1 to 6

Prewashing treatment compositions for clothes shown in Tables 1 and 2 were prepared. All the pHs of the obtained compositions of these examples at 20° C. were 10 to 11. The viscosities of these compositions of examples were all 2 to 15 mPa·s (B-type viscometer, 20° C., 60 r/min).

Each detergency of these compositions was evaluated by the method shown below. The results are shown in Tables 1 and 2.

<Evaluation of detergency>

(Preparation of a Cloth With Dirt on the Collar)

A cloth with dirt on the collar as described in JIS K 3362: 1998 was prepared.

(Washing Condition and Evaluation Method)

40 L of water as described in JIS K3362:1998 for use was poured into the washing bath of an automatic two-bath type washer (Toshiba Ginga 3.6), in which 1.4 kg of unworn underwear made of cotton and 0.6 kg of an unworn shirt made of cotton cloth with a polyester mix was then placed. Further, 53 g (the weight calculated as the anhydride) of an indicator detergent for determining detergency (without the addition of a fluorescent whitening agent) as described in JIS K 3362: 1998 was poured into the washer. Further, 6 pieces of cloth (with three grades of dirt every two pieces) to which 4 g of the prewashing treatment composition for clothes was applied per each of the cloth with dirt on the collar and then allowed to stand for 5 minutes were placed in the washer and washed normally for 10 minutes. Thereafter, a dewatering operation was carried out for one minute, followed by rinsing in a water stream at a rate of 15 L/min for 8 minutes. Then, a dewatering operation was carried out for 5 minutes, followed by being dried indoor.

The same clothes as above were treated in the same manner as above without applying the prewashing treatment composition for clothes as controls. The above clothes treated by applying the prewashing treatment composition were visually compared with the controls every each pair to evaluate according to the following criterion.

Evaluation Criterion

⊚: Dirt comes off more clearly than in the case of the controls in all the three grades of dirt.

◯: Dirt comes off somewhat clearly than in the case of the controls in all the three grades of dirt.

x: Dirt comes off on almost the same level as or a lower level than in the case of the controls in all the three grades of dirt.

TABLE 1

| | | Example | | | | | Comparative Example | | |
|---|---|---|---|---|---|---|---|---|---|
| Component (mass %) | | 1 | 2 | 3 | 4 | 5 | 1 | 2 | 3 |
| (a) | Amphiprotic surfactant1 | 3 | 3 | 2.5 | 3 | 2.5 | 3 | 3 | 15 |
| | Amphiprotic surfactant2 | | 0.5 | | | 05 | | | |
| | Amphiprotic surfactant3 | 0.5 | | 0.5 | 0.5 | 0.5 | 0.5 | 0.5 | |
| | Nonionic surfactant 1 | 0.5 | | | | | 0.5 | 0.5 | |
| | Nonionic surfactant 2 | | 0.5 | | | | | | |
| | Anionic surfactant 1 | | | 0.5 | | | | | |
| | Anionic surfactant 2 | | | | 0.5 | | | | |
| (b) | Chelating agent b1 | 5 | | | | | | | |
| | Chelating agent b2 | | 5 | | | | | | |
| | Chelating agent b3 | | | 5 | | | | | |
| | Chelating agent b4 | | | | 5 | | | | |
| | Chelating agent b5 | | | | | 5 | | 5 | 5 |
| (c) | Water | balance | balance | balance | balance | balance | balance | balance | balance |
| (d) | Sodium carbonate | 10 | 10 | 10 | 10 | 10 | 10 | | 10 |
| | Diethanolamine | | | | | | | | |
| (e) | Ethanol | 2 | 2 | 2 | 2 | 2 | 2 | 2 | 2 |
| | Propyleneglycol | 2 | 2 | 2 | 2 | 2 | 2 | 2 | 2 |
| | p-toruenesulfonic | 2 | 2 | 2 | 2 | 2 | 2 | 2 | 2 |
| | acid monohydride | | | | | | | | |
| Others | Citric acid | | | | | | 5 | | |
| | Enzyme | | | | | | | | |
| | Dye | | | | | | | | |
| | Perfume | 0.2 | 0.2 | 0.2 | 0.2 | 0.2 | 0.2 | 0.2 | 0.2 |

| | | | | | | | | |
|---|---|---|---|---|---|---|---|---|
| Total | 100 | 100 | 100 | 100 | 100 | 100 | 100 | 100 |
| Detergency | ⊚ | ⊚ | ⊚ | ⊚ | ⊚ | x | x | x |

TABLE 2

| | | Example | | | | | | | | | Comparative example | | |
|---|---|---|---|---|---|---|---|---|---|---|---|---|---|
| Component (mass %) | | 6 | 7 | 8 | 9 | 10 | 11 | 12 | 13 | 14 | 4 | 5 | 6 |
| (a) | Amphiprotic surfactant1 | 2 | | 3 | 3 | 2.5 | 2.5 | 2.5 | 2 | | 3 | 3 | 15 |
| | Amphiprotic surfactant2 | | | | | | | 0.5 | | | | | |
| | Amphiprotic surfactant3 | 0.5 | | 0.5 | 0.5 | 0.5 | 0.5 | 0.5 | 0.5 | | 0.5 | 0.5 | |
| | Nonionic surfactant 1 | 0.5 | 2 | 0.5 | | | | 0.3 | | 2 | 0.5 | 0.5 | |
| | Nonionic surfactant 2 | | | | | 0.5 | | | | | | | |
| | Anionic surfactant 1 | | | | | | 0.5 | | | | | | |
| | Anionic surfactant 2 | | 2 | | | | | 0.2 | | 2 | | | |
| (b) | Chelating agent b1 | 3 | | 3 | 5 | | | | | | | | |
| | Chelating agent b2 | 3 | | | | 5 | | | | | | | |
| | Chelating agent b3 | | | 3 | | | 5 | | | | | | |
| | Chelating agent b4 | | | | | | | 5 | | | | | |
| | Chelating agent b5 | | 5 | | | | | | 5 | 5 | | 5 | 5 |
| (c) | Water | balance | balance | balance | balance | balance | balance | balance | balance | balance | balance | balance | balance |
| (d) | Sodium carbonate | 8 | | 10 | | 5 | | | 5 | | 10 | | 10 |
| | Potassium carbonate | 5 | 15 | | 5 | 5 | 5 | 5 | | | | | |
| | Monoethanolamine | 2 | 2 | | | | | | 5 | 15 | | | |
| (e) | Ethanol | 2 | 2 | 2 | 2 | 2 | 2 | 2 | 2 | 2 | 2 | 2 | 2 |
| | Propyleneglycol | 2 | 2 | 2 | 2 | 2 | 2 | 2 | 2 | 2 | 2 | 2 | 2 |
| | p-toruenesulfonic | 3 | 1 | 2 | 1.5 | 1.5 | 1.5 | 1.5 | 1.5 | 1 | 2 | 2 | 2 |
| | acid monohydride | | | | | | | | | | | | |
| (f) | Chelating agent f1 | | | 1 | | | 0.5 | | | 1 | | | |
| | Chelating agent f2 | | | | 1 | | | 1 | 2 | | | | |
| | Chelating agent f3 | 0.5 | 0.5 | | | 1 | 0.5 | 0.5 | | | | | |
| Others | Citric acid | | | | | | | | | | 5 | | |
| | Sodium sulfite | | | | 0.1 | 0.1 | 0.1 | 0.1 | 0.1 | | | | |
| | Enzyme | 1 | 1 | 1 | 1 | 1 | 1 | 1 | 1 | 1 | 1 | 1 | 1 |
| | Dye | minute | minute | minute | minute | minute | minute | minute | minute | minute | minute | minute | minute |
| | | amount | amount | amount | amount | amount | amount | amount | amount | amount | amount | amount | amount |
| | Perfume | 0.2 | 0.2 | 0.3 | 0.3 | 0.3 | 0.3 | 0.3 | 0.3 | 0.3 | 0.3 | 0.3 | 0.3 |

| | | | | | | | | | | | | |
|---|---|---|---|---|---|---|---|---|---|---|---|---|
| Total | 100 | 100 | 100 | 100 | 100 | 100 | 100 | 100 | 100 | 100 | 100 | 100 |
| Detergency | ⊚ | ∘ | ⊚ | ⊚ | ⊚ | ⊚ | ⊚ | ⊚ | ∘ | x | x | x |

Amphoteric surfactant 1: Lauramidopropylamine oxide (Softazoline LAO-C, manufactured by Kawaken Fine Chemical K.K., amount converted into pure content)
Amphoteric surfactant 2: Dimethyllaurylamine oxide (Amphitol 20 N, manufactured by Kao Corporation, amount converted into pure content)
Amphoteric surfactant 3: Lauryl(2-hydroxy-3-sulfopropyl) dimethylbetaine (Amphitol 20HD, manufactured by Kao Corporation, amount converted into pure content)
Nonionic surfactant 1: Decyl glucoside (Mydol 10, manufactured by Kao Corporation, amount converted into pure content)
Nonionic surfactant 2: Surfactant obtained by adding ethylene oxide in an average amount of 8 mol and propylene oxide in an average amount of 2 mol at random to a straight-chain primary alcohol having 10 to 14 carbon atoms
Anionic surfactant 1: Sodium salt of coconut oil fatty acid
Anionic surfactant 2: Sodium alkylbenzenesulfonate containing a linear alkyl group having 10 to 14 carbon atoms
Chelating agent b1: Trisodium methylglycinediacetate (Trilon M, BASF Japan K.K., amount converted into pure content) (Ca-capture amount: 430 CaCO₃ mg/g, Ca stability constant: 6.1)
Chelating agent b2: Tetrasodium aspartic acid-N, N-diacetate (Ca-capture amount: 328 CaCO₃ mg/g, Ca stability constant: 6.7)
Chelating agent b3: Trisodium serinediacetate (Ca-chelating capacity: 347 CaCO₃ mg/g, Ca stability constant: 6.5)
Chelating agent b4: Tetrasodium glutamic acid diacetate (Ca-capture amount: 305 CaCO₃ mg/g, Ca stability constant: 5.8)
Chelating agent b5: Trisodium ethylglycinediacetate (Ca-chelating capacity: 419 CaCO₃ mg/g, Ca stability constant: 5.7)
Chelating agent f1: Sodium polyacrylate (weight average molecular weight: 5000, Ca-chelating capacity: 205 CaCO₃ mg/g, Ca stability constant: 3.4)
Chelating agent f2: Aqualic DL365 (sodium polyacrylate manufactured by Nippon Shokubai Kagaku Kogyo Co., Ltd., weight average molecular weight: 5000, Ca-chelating capacity: 220 CaCO₃ mg/g, Ca stability constant: 3.2)
Chelating agent f3: High molecular compound (1) synthesized in a Synthetic Example 1 (weight average molecular weight: 10000, Ca-chelating capacity: 75 CaCO₃ mg/g, Ca stability constant: 3.6) described in the publication of JP-A No. 10-60476, page 4, Paragraph No. 0020
Enzyme: Everlase 16.0 L-EX (protease, manufactured by Novozymes)
Dye 1: Kayacion Orange (added in an amount of 10 ppm (mass ratio) to the composition)
Dye 2: Kayacion Turquoise KNA (added in an amount of 10 ppm (mass ratio) to the composition)
The dye 1 is used in Examples 6 and 7 and the dye 2 is used in other examples.

1. A prewashing treatment composition for clothes, comprising: (a) 0.05 to 10 mass % of a surfactant; (b) 1 to 30 mass % of a chelating agent having a calcium-chelating capacity of 200 to 600 CaCO₃ mg/g, a stability constant of calcium complex of 4 to 10 and a molecular weight of 1000 or less; (c) 50 to 95 mass % of water; and (d) 1 to 30 mass % of an alkali agent, and having a pH of 7.5 to 12 when measured at 20° C.

2. A prewashing treatment composition for clothes according to claim 1, wherein the chelating agent (b) is a compound represented by the following formula (I): 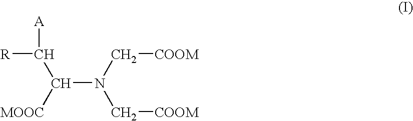
wherein R represents —(CH₂)ₙ-A, A represents H, OH or COOM, M represents H, Na, K or NH₄ and n denotes a number from 0 to 5.

3. A prewashing treatment composition for clothes according to claim 1 or 2, wherein the chelating agent (b) is a compound having the characteristics that the maximum pH of an aqueous solution or a dispersion containing the chelating agent (b) at a concentration of 0.025 mass % is 10 or more (20° C.) and 10 ml or more of an aqueous 0.1 N hydrochloric acid solution is required to adjust 1 l of the aqueous solution or dispersion to pH 9 (20° C.).

4. A prewashing treatment composition for clothes according to any one of claims 1 to 3, wherein 50 mass % or more of the surfactant (a) is a compound represented by the following formula (II): 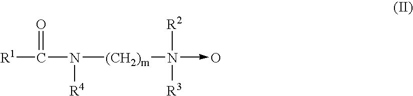
wherein R¹ represents an alkyl group or an alkenyl group having 7 to 20 carbon atoms, R² and R³ respectively represent an alkyl group or an alkenyl group having 1 to 3 carbon atoms, R⁴ represents a hydrogen atom or an alkyl group or an alkenyl group having 1 to 5 carbon atoms and m denotes a number of 1 to 5.

5. A prewashing treatment composition for clothes according to anyone of claims 1 to 4, the composition further comprising (e) a hydrotropic agent in an amount of 1 to 30 mass %.

6. A prewashing treatment composition for clothes according to anyone of claims 1 to 5, the composition further comprising (f) a chelating agent having a calcium-chelating capacity of 20 to 500 CaCO₃ mg/g, a stability constant of calcium complex of 1 to 8 and a molecular weight of 2000 or more in an amount of 0.05 to 15 mass %.

7. A prewashing treatment composition for clothes according to claim 6, wherein the ratio by mass of the chelating agent (f)/the chelating agent (b) is 1/50 to 1/1.

8. A prewashing treatment composition for clothes according to any one of claim 6 or 7, wherein the stability constant of calcium complex of the chelating agent (b) is greater than that of the chelating agent (f).

9. A prewashing treatment composition for clothes according to any one of claims 6 to 8, wherein (the calcium-chelating capacity (CaCO₃ mg/g) of the component (b)×the concentration (mass %) of the component (b) in the composition) is larger than (the calcium-chelating capacity (CaCO₃ mg/g) of the component (f)×the concentration (mass %) of the component (f) in the composition).

10. A method of washing clothes, the method comprising applying the prewashing treatment composition for clothes as claimed in any one of claims 1 to 9 to clothes prior to washing in an atomized or foamed state and then washing the clothes by using a detergent.
